(19) United States
(12) Patent Application Publication
(10) Pub. No.: US 2017/0213177 A1
(43) Pub. Date: Jul. 27, 2017

(54) METHODS AND SYSTEMS FOR AUTO BENCHMARKING OF ENERGY CONSUMING ASSETS ACROSS DISTRIBUTED FACILITIES

(71) Applicant: Wipro Limited, Bangalore (IN)

(72) Inventors: Subhasis MANDAL, Bangalore (IN); Ravi MEGHANI, Bangalore (IN)

(73) Assignee: Wipro Limited

(21) Appl. No.: 15/063,882

(22) Filed: Mar. 8, 2016

(30) Foreign Application Priority Data
Jan. 22, 2016 (IN) 201641002445

(51) Int. Cl. G06Q 10/06; G06Q 50/06

(52) U.S. Cl. CPC G06Q 10/06393; G06Q 50/06

(57) ABSTRACT

In one embodiment, a method of benchmarking energy assets is disclosed. The method includes filtering asset data received from a plurality of energy assets based on constraints to generate filtered asset data; creating a plurality of data profiles using the filtered asset data based on profiling variables; identifying at least one benchmarking variable and at least one normalizing variable for the plurality of energy assets for a data profile in the plurality of data profiles; iteratively determining correlation between the at least one benchmarking variable and the at least one normalizing variable; and normalizing the at least one benchmarking variable using the at least one normalizing variables in response to determining the correlation to generate benchmarks for each of the at least one benchmarking variable.

### TECHNICAL FIELD

This disclosure relates generally to management of energy assets and more particularly to methods and systems for auto benchmarking of energy consuming assets across distributed facilities.

### BACKGROUND

According to the International Energy Agency (IEA), world energy outlook report 2010, demand for energy in the world is expected to increase drastically in coming few decades. Whereas, sources and supply of conventional energy like electricity from utility companies is going to be limited. This may lead to a huge supply-demand gap in energy. Also, the energy needs to be efficiently used to reduce carbon footprint. One of the major challenges faced by large consumers of energy, for example, a distributed facility or a process plant is to reduce energy consumption without compromising on the quality of operating conditions and quality of services.

In conventional methods, energy consuming assets are managed using methods for overall energy performance benchmarks. However, benchmarks for assets or asset groups and system level benchmarks are not well established. As a result, deciding the right indicators of performance of an energy asset or asset groups is a challenge. Moreover, as energy assets operate in response to loads and various other dependent variables. It becomes paramount to determine norms for taking these dependent variables into account while managing the energy consuming assets.

### SUMMARY

In one embodiment, a method of benchmarking energy assets is disclosed. The method includes filtering asset data received from a plurality of energy assets based on constraints to generate filtered asset data; creating a plurality of data profiles using the filtered asset data based on profiling variables; identifying at least one benchmarking variable and at least one normalizing variable for the plurality of energy assets for a data profile in the plurality of data profiles; iteratively determining correlation between the at least one benchmarking variable and the at least one normalizing variable; and normalizing the at least one benchmarking variable using the at least one normalizing variables in response to determining the correlation to generate benchmarks for each of the at least one benchmarking variable.

In another embodiment, a system for rationalizing a portfolio of assets is disclosed. The system includes at least one processors and a computer-readable medium. The computer-readable medium stores instructions that, when executed by the at least one processor, cause the at least one processor to perform operations that includes filtering asset data received from a plurality of energy assets based on constraints to generate filtered asset data; creating a plurality of data profiles using the filtered asset data based on profiling variables; identifying at least one benchmarking variable and at least one normalizing variable for the plurality of energy assets for a data profile in the plurality of data profiles; iteratively determining correlation between the at least one benchmarking variable and the at least one normalizing variable; and normalizing the at least one benchmarking variable using the at least one normalizing variables in response to determining the correlation to generate benchmarks for each of the at least one benchmarking variable.

In yet another embodiment, a non-transitory computer-readable storage medium for rationalizing a portfolio of assets is disclosed, which when executed by a computing device, cause the computing device to: filter asset data received from a plurality of energy assets based on constraints to generate filtered asset data; create a plurality of data profiles using the filtered asset data based on profiling variables; identify at least one benchmarking variable and at least one normalizing variable for the plurality of energy assets for a data profile in the plurality of data profiles; iteratively determine correlation between the at least one benchmarking variable and the at least one normalizing variable; and normalize the at least one benchmarking variable using the at least one normalizing variables in response to determining the correlation to generate benchmarks for each of the at least one benchmarking variable.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary computer system for implementing various embodiments.

FIG. 2 is a block diagram illustrating a system for auto benchmarking energy assets, in accordance with an embodiment.

FIG. 3 illustrates a flowchart of a method for auto benchmarking energy assets, in accordance with an embodiment.

FIG. 4 illustrates a flowchart of a method for auto benchmarking energy assets, in accordance with another embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

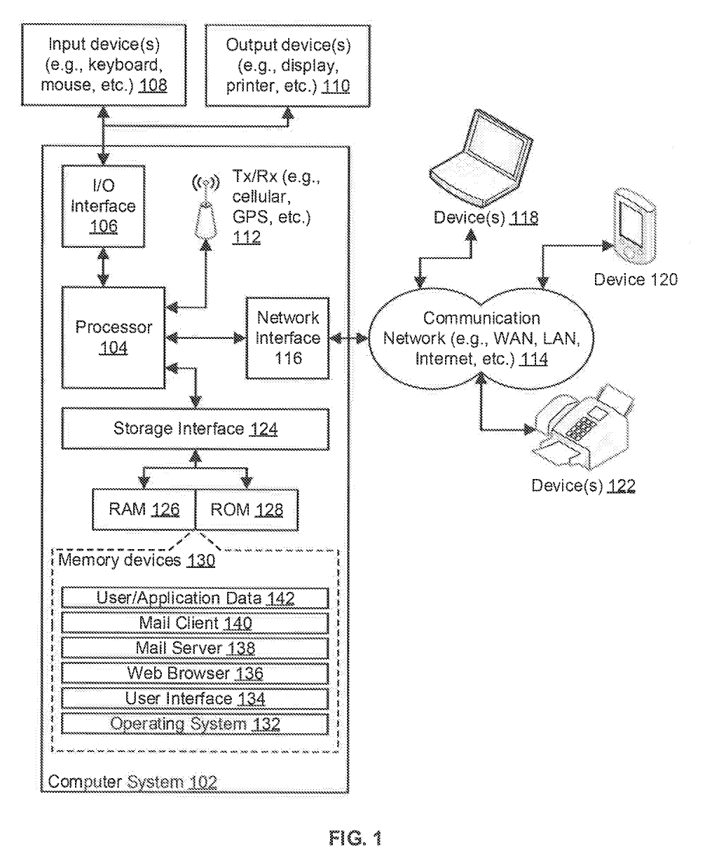

Additional illustrative embodiments are listed below. In one embodiment, a block diagram of an exemplary computer system for implementing various embodiments is disclosed in FIG. 1. Computer system 102 may comprise a central processing unit (“CPU” or “processor”) 104. Processor 104 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. Processor 104 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 104 may be disposed in communication with one or more input/output (I/O) devices via an I/O interface 106. I/O interface 106 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 106, computer system 102 may communicate with one or more I/O devices. For example, an input device 108 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 110 may be a printer, fax machine, video display (e.g., cathode ray tube (CRT), liquid crystal display (LCD), light-emitting diode (LED), plasma, or the like), audio speaker, etc. In some embodiments, a transceiver 112 may be disposed in connection with processor 104. Transceiver 112 may facilitate various types of wireless transmission or reception. For example, transceiver 112 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 104 may be disposed in communication with a communication network 114 via a network interface 116. Network interface 116 may communicate with communication network 114. Network interface 116 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 114 may include, without limitation, a direct interconnection, local area network (LAN), wide area network (WAN), wireless network (e.g., using Wireless Application Protocol), the Internet, etc. Using network interface 116 and communication network 114, computer system 102 may communicate with devices 118, 120, and 122. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 102 may itself embody one or more of these devices.

In some embodiments, processor 104 may be disposed in communication with one or more memory devices (e.g., RAM 126, ROM 128, etc.) via a storage interface 124. Storage interface 124 may connect to memory devices 130 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 130 may store a collection of program or database components, including, without limitation, an operating system 132, a user interface application 134, a web browser 136, a mail server 138, a mail client 140, a user/application data 142 (e.g., any data variables or data records discussed in this disclosure), etc. Operating system 132 may facilitate resource management and operation of the computer system 102. Examples of operating system 132 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 134 may facilitate display, execution, interaction, manipulation, or operation of program components through textual or graphical facilities. For example, user interfaces may provide computer interaction interface elements on a display system operatively connected to computer system 102, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 102 may implement web browser 136 stored program component. Web browser 136 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 102 may implement mail server 138 stored program component. Mail server 138 may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, computer system 102 may implement mail client 140 stored program component. Mail client 140 may be a mail viewing application, such as Apple Mail, Microsoft Entourage, Microsoft Outlook, Mozilla Thunderbird, etc.

In some embodiments, computer system 102 may store user/application data 142, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

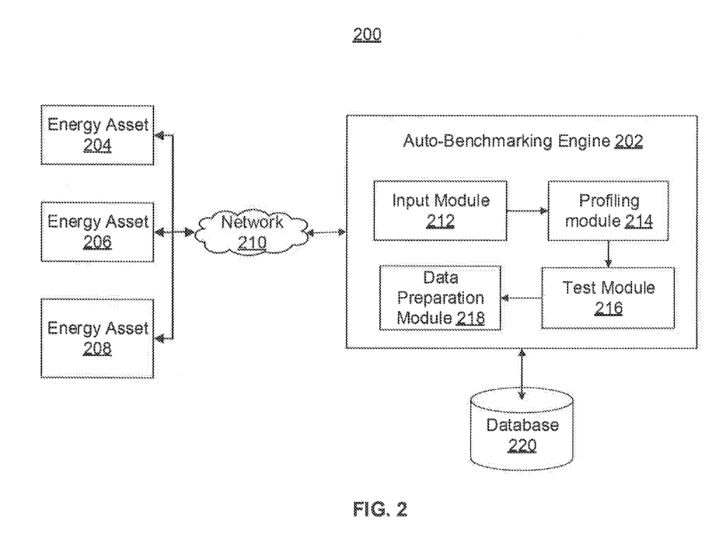

FIG. 2 is a block diagram illustrating a system 200 for auto benchmarking energy assets, in accordance with an embodiment. System 200 includes an auto-benchmarking engine 202 that communicates with a plurality of energy assets (for example, an energy asset 204, an energy asset 206, and an energy asset 208). Examples of the plurality of energy assets may include, but are not limited to Heating Ventilation and Air-Conditioning (HVAC) units of different types, electrical systems, like, power conditioning and supply systems, transformers, energy generation sources, like, generators with different fuel sources including cogeneration plants and solar plants, lighting units, smart devices, sensors and meters. The plurality of energy assets may be placed at different locations within the same facility of a single organization. Alternatively, each of the plurality of energy assets may be located at distributed facilities of the same or multiple organizations, such that the distributed facilities are located at different geographical locations. Each of these different geographical locations may also have diverse climatic conditions. The communication between auto-benchmarking engine 202 and the plurality of energy assets is facilitated through a network 210. Network 210 may be a wired or a wireless network. Examples of network 210 may include, but are not limited to Local Area Network (LAN), Metropolitan Area Network (MAN), Wide Area Network (WAN) or the Internet.

Auto-benchmarking engine 202 may collect asset data from the plurality of energy assets. Alternatively, each of the plurality of energy assets may be programmed to periodically provide asset data to auto-benchmarking engine 202. In an embodiment, an energy asset may be programmed to communicate asset data to auto-benchmarking engine 202, when one or more energy parameters for the energy asset breach an associated threshold. For example, in a roof-top AC unit, when temperature of the compressor rises above a threshold temperature, it may communicate multiple parameter readings that affect the rise in temperature to auto-benchmarking engine 202. Asset data associated with an energy asset may include, but is not limited to temperature of the asset, pressure associated with the asset, flow associated with the asset, power associated with the asset, run-hours of the asset, utilization level of the asset, damper states of the asset, operating speeds of the asset, operation state of the asset, humidity levels of the asset, consumption of the asset, and calibration errors in measuring devices.

Auto-benchmarking engine 202 further includes an input module 212, a profiling module 214, a test module 216, and a data preparation module 218. Auto-benchmarking engine 202 also communicates with a database 220. In an embodiment, database 220 may be located within auto-benchmarking engine 202. Asset data collected from the plurality of assets is received by input module 212, which then filters the asset data based on constraints to generate filtered asset data. Examples of the constraints that are used to filter the asset data may include, but are not limited to one or more of inactive assets, failed assets, and assets with missing data.

Using the filtered asset data, input module 212 determines the impacting variables and the benchmark variables. In an embodiment, the impacting variables are independent variables and may include, but are not limited to business policy, outside air temperature, location area and operation pattern of the facility (helps in determining facility characteristics like climate and period of energy usages by different assets), and control parameters. Control parameters, for example, may include, but are not limited to Original Equipment Manufacturer (OEM) specified adjustable configuration parameters in assets or asset groups and customer specified ranges (for example, policy set-point range).

The impacting variables are of two types, i.e., normalizing variables and profiling variables. Normalizing variables, for example, may include, but are not limited to outside air temperature, outside air humidity, outside air dewpoint, age of an asset, area served, available capacity of an asset group, Zone temperature maintained by an asset group. Further, the profiling variables, for example, may include but are not limited to type of operations, facility type, day of the week (weekend or weekday), climate zones, and asset make. The type of operations may include different operation patterns for a retail facility, for example, store close hours, employee hours, and business hours.

Similarly, the benchmark variables are also of two types. These variables may be commonly measured performance parameters that may already be know. Examples may include, but are not limited to supply temperature for an asset, supply static pressure for an asset, refrigerant pressure for an asset, and zone temperature for an asset or an asset group. Alternatively, these variables may be derived parameters and the examples may include, but are not limited to run-hours of an asset or an asset group, consumption of an asset or an asset groups, set-points maintained, and temperature difference across input and output of an asset. In an embodiment, a set of benchmark variables may act as impacting variables for another set of benchmark variables.

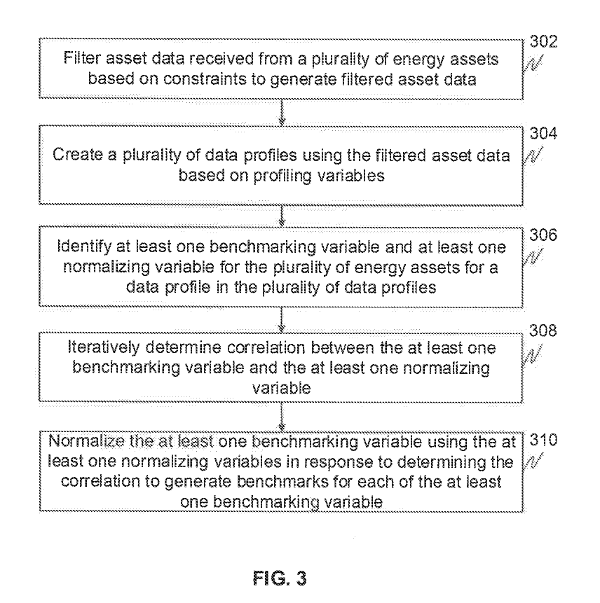

The asset data that is received by input module 212 may be structured or unstructured. Input module 212 transforms this asset data into derived variables, input materiality, thresholds, and other configuration parameters. Further, if the asset data includes some known errors, input module 212 may further clean these errors or substitute missing values. The information extracted and derived by input module 212 is used by profiling module 214 to create a plurality of data profiles using the filtered asset data based on profiling variables. Input module 212 identifies data profiles in which benchmarking is required. Thereafter, profiling module 214 uses benchmark variables and impacting variables derived by input module 212 to benchmark each of the plurality of energy assets for these data profiles. This is further explained in detail in conjunction with an example described in FIG. 3.

Test module 216 tests the materiality of impact that an impacting variable has on a benchmark variable. In an embodiment, test module 216 may test the materiality of impact of a set of impacting variables on a benchmark variable. Thereafter, data preparation module 218 determines normalization coefficients of normalization variables for benchmarking variables. For example, a normalization coefficient may be determined by comparing a benchmark variable with a normalization variable. The normalization coefficient may then be used to determine the impact of a normalizing variable on a benchmark variable for an asset at different locations. In other words, data preparation module 218 applies normalization coefficient to get normalized benchmarking variable data under a particular profile within limits of normalization variable. Data preparation module 218 thus benchmarks a benchmark variable across multiple sites for one or more assets or one or more asset groups.

FIG. 3 illustrates a flowchart of a method for auto benchmarking energy assets, in accordance with an embodiment. To this end, asset data is collected from a plurality of energy assets. The plurality of energy assets may be distributed across multiple geographical locations. Asset data for an energy asset, for example, may include, but is not limited to temperature of the asset, pressure associated with the asset, flow associated with the asset, power associated with the asset, run-hours of the asset, utilization level of the asset, damper states of the asset, operating speeds of the asset, operation state of the asset, humidity levels of the asset, and consumption of the asset.

Thereafter, at 302 the asset data received from the plurality of energy assets is filtered based on constraints to generate filtered asset data. Examples of a constraint may include, but are not limited to one or more of inactive assets, failed assets, and assets with missing data. The filtered asset data is then used at 304 to create a plurality of data profiles based on profiling variables. The profiling variables may include, but are not limited to type of operations, facility type, day of the week (weekends, weekday, or national holidays), climate zones, and asset make. For example, for a particular retail chain, there may be a separate data profile for certain special event days (for example, Black Friday) and a separate data profile for weekends and separate data profile for weekdays in the year. The reason being that, on those special event days the number of footfalls in the shopping mart would be much higher throughout the day, when compared to that on a weekend or other weekdays. Thus, the HVAC units would have to run on a much higher capacity on those special event days, as compared to that on other days.

At 306, for one of the data profiles, one or more benchmarking variables and one or more normalizing variables are identified for the plurality of energy assets. In other words, firstly a data profile is selected and for that particular data profile benchmarking variables and normalizing variables are identified. Benchmarking variables, for example, may include run-hours of an asset or asset group, supply temperature for an asset, supply static pressure for an asset, refrigerant pressure for an asset, and zone temperature for an asset or an asset group. These benchmarking variables are normalized based on the normalizing variables, which for example, may include, but are not limited to outside air temperature, outside air humidity, outside air dewpoint, age of an asset, area served, zone temperature maintained, and available capacity of an asset group. For example run-hours of an HVAC asset or an asset group should ideally vary for different geographical locations and zone temperature achieved by the assets. Thus run-hours would be normalized based on outside air temperature and the zone temperature maintained. As a result, benchmark run-hours would increase or decrease based on average outside temperature as well as temperature maintained.

Thereafter, at 308, correlation between the one or more benchmarking variables and the one or more normalizing variables that are identified at 306 is iteratively determined. In other words, the impact of the one or more normalization variables on performance of a benchmark variable is iteratively determined in order to identify those normalizing variables that really have an impact on performance of the benchmark variable in real practice. The reason for doing so is that a normalizing variable may be assumed to have a significant impact on performance of a benchmark variable. However, in real practice, this might not be true. Moreover, other normalizing variables, individually or in combination thereof, may also have a significant impact on performance of the benchmark variable.

Moreover, while determining the correlation, one or more normalization coefficient associated with the one or more normalizing variable are also determined for each of the one or more benchmarking variables. A normalization coefficient helps in establishing a relationship between a normalizing variable and a benchmarking variable, such that, the normalizing variable is able to effectively normalize the benchmarking variable data for a particular data profile. Only when materiality criteria set by test module 216 for normalizing variables is met, these normalizing variables are adopted for future analysis.

Once the normalizing variables have been identified and normalization coefficient have been arrived at, the one or more benchmarking variable are normalized using the one or more normalizing variables to generate benchmarks for each of the one or more benchmarking variables at 310. To this end, a normalization coefficient is applied to an associated benchmark variable to generate normalized asset data.

As an example of the method described above, benchmarking of run-hours of a roof top AC unit compressor is discussed. In this example, the benchmark variable is run-hours, profiling variable is operation hours, and the normalizing variable is Outside Air Temperature (OAT). The climate zone is represented as 3A and run-hours is computed using equation 1 given below:

F(OPₕᵣₛ,OAT)=Run-hours(AH)+Run-hours(PH)+Run-hours(NH) (1)

where,
F(OPₕᵣₛ, OAT)=Total run-hours being a function of operation hours (OPₕᵣₛ) and OAT;
AH=Afterhours;
PH=Partial hours;
NH=Normal hours, each of AH, PH, and NM being different data profiles for types of operation hours

The total run-hours, in this example, may further be represented by equations 2, 3, 4, and 5 given below:

f(T_{AH,3A})*H_{AH,3A}+f(T_{PH,3A})*H_{PH,3A}+f(T_{NH,3A})*H_{NH,3A} (2)

f(T_{AH,3A})=(a0_{ah,3A}+a1_{AH,3A}*T+a2_{AH,3A}*T̂²) (3)

f(T_{PH,3A})=(a0_{PH,3A}+a1_{PH,3A}*T+a2_{PH,3A}*T̂²) (4)

f(T_{NH,3A})=(a0_{NH,3A}+a1_{NH,3A}*T+a2_{NH,3A}*T̂²) (5)

where,
T is a variable representing OAT;
H is a variable representing number of hours in operation; and
a0, a1 and a2 are normalizing coefficients respective to the climate zone 3A and operation profile.

Thus, for the climate zone 3A, using the equations 2, 3, 4, and 5, benchmark values for the run-hours of a roof top AC unit compressor may be computed. Similarly, for other climate zones (which will decide the normalizing variables), a normalized benchmark value for the run-hours of a roof top AC unit compressor may be computed.

After benchmarks for each of the one or more benchmarking variables have been generated, benchmarked values for each asset along with the minimum, maximum and mean values is presented. These values may either be represented in text form, league tables, or visually with options to view the benchmark values in conjunction with one or more normalizing or profiling variables.

The auto-benchmarking method describes above looks at performance of all operating parameters (for example, run-hours, utilization level, damper states, operating speeds, and humidity levels) and profiles them as per various data profiles. When this method is carried out across the assets, asset groups, sites across multiple organizations, it enables us in determining the benchmarks. As a result, the need for establishing very elaborate benchmarking methodologies is eliminated. The advantages of the methods are that performance outliers or abnormal operating conditions are effectively determined and asset failures are proactively identified.

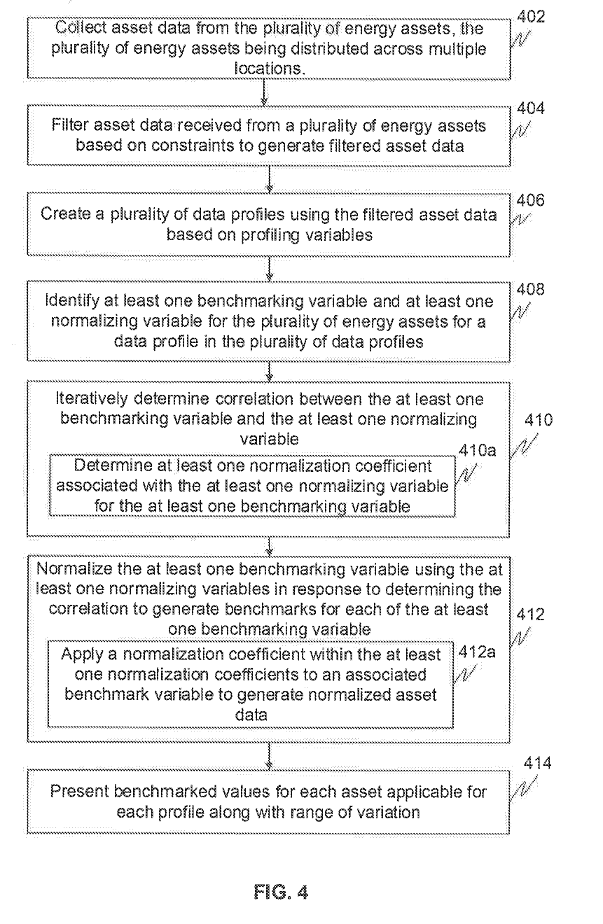

FIG. 4 illustrates a flowchart of a method for auto benchmarking energy assets, in accordance with another embodiment. At 402, asset data is collected from a plurality of energy assets. The plurality of energy assets may distributed across multiple geographical locations. Asset data for an energy asset, for example, may include, but is not limited to temperature of the asset, pressure associated with the asset, flow associated with the asset, power associated with the asset, run-hours of the asset, utilization level of the asset, damper states of the asset, operating speeds of the asset, operation state of the asset, humidity levels of the asset, and consumption of the asset.

The asset data received from the plurality of energy assets is filtered based on constraints to generate filtered asset data at 404. This filtered asset data is then used to create a plurality of data profiles based on profiling variables at 406. Thereafter, at 408, one or more benchmarking variables and one or more normalizing variables are identified for the plurality of energy assets for a data profile in the plurality of data profiles. A correlation between the one or more benchmarking variable and the one or more normalizing variables is then iteratively determined at 410. While determining the correlation, at 410a, one or more normalization coefficient associated with the one or more normalizing variable are also determined for each of the one or more benchmarking variables. This has been explained in detail in conjunction with FIG. 3.

Thereafter, at 412, the one or more benchmarking variables are normalized using the one or more normalizing variables in response to determining the correlation to generate benchmarks for each of the one or more benchmarking variables. To generate normalized asset data, a normalization coefficient within the one or more normalization coefficients is applied to an associated benchmark variable at 412a. The benchmarked values for each asset applicable for each profile along with range of variation are then presented at 414. The benchmarked values for each asset may be presented along with their minimum, maximum and mean values. This has been explained in detail in conjunction with FIG. 3.

Various embodiments of the invention provide methods and system for auto benchmarking of energy consuming assets across distributed facilities. Auto-benchmarking looks at performance of all the operating parameters (for example, run-hours, utilization level, damper states, operating speeds, and humidity levels) and profiles them as per various data profiles. When this method is carried out across the assets, asset groups, sites across multiple organizations, it enables us in determining the benchmarks. As a result, the need for establishing very elaborate benchmarking methodologies is eliminated. The advantages of the methods are that performance outliers or abnormal operating conditions are effectively determined and asset failures are proactively identified.

The specification has described methods and system for auto benchmarking of energy consuming assets across distributed facilities. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of benchmarking energy assets, the method comprising:
filtering asset data received from a plurality of energy assets based on constraints to generate filtered asset data;
creating a plurality of data profiles using the filtered asset data based on profiling variables;
identifying at least one benchmarking variable and at least one normalizing variable for the plurality of energy assets for a data profile in the plurality of data profiles;
iteratively determining correlation between the at least one benchmarking variable and the at least one normalizing variable; and
normalizing the at least one benchmarking variable using the at least one normalizing variables in response to determining the correlation to generate benchmarks for each of the at least one benchmarking variable.

2. The method of claim 1, wherein iteratively determining correlation comprises determining at least one normalization coefficient associated with the at least one normalizing variable for the at least one benchmarking variable.

3. The method of claim 2, wherein normalizing comprises applying a normalization coefficient within the at least one normalization coefficients to an associated benchmark variable to generate normalized asset data.

4. The method of claim 1 further comprising presenting benchmarked values for each asset along with the minimum, maximum and mean values.

5. The method of claim 1 further comprising collecting asset data from the plurality of energy assets, the plurality of energy assets being distributed across multiple locations.

6. The method of claim 1, wherein asset data for an asset is selected from a group comprising temperature of the asset, pressure associated with the asset, flow associated with the asset, power associated with the asset, run-hours of the asset, utilization level of the asset, damper states of the asset, operating speeds of the asset, operation state of the asset, humidity levels of the asset, consumption of the asset.

6. The method of claim 1, wherein the at least one profiling variable is selected from a group comprising type of operations, facility type, day of the week, climate zones, and asset make.

7. The method of claim 1, wherein the at least one benchmarking variable is selected from a group comprising zone temperature for an asset or an asset group, supply temperature for an asset, supply static pressure for an asset, refrigerant pressure for an asset, run-hours for an asset, temperature difference across asset input/output, consumption of an asset or an asset group, and setpoints maintained.

8. The method of claim 1, wherein the at least one normalizing variable is selected from a group comprising outside air temperature, outside air humidity, outside air dewpoint, age of an asset, area served, available capacity of the group, and zone temperature maintained by the group.

9. The method of claim 1, wherein constraints to filter the asset data comprises at least one of failed assets and assets with missing data.

10. A system for benchmarking energy assets, the system comprising:
at least one processors; and
a computer-readable medium storing instructions that, when executed by the at least one processor, cause the at least one processor to perform operations comprising:
filtering asset data received from a plurality of energy assets based on constraints to generate filtered asset data;
creating a plurality of data profiles using the filtered asset data based on profiling variables;
identifying at least one benchmarking variable and at least one normalizing variable for the plurality of energy assets for a data profile in the plurality of data profiles;
iteratively determining correlation between the at least one benchmarking variable and the at least one normalizing variable; and
normalizing the at least one benchmarking variable using the at least one normalizing variables in response to determining the correlation to generate benchmarks for each of the at least one benchmarking variable.

11. The system of claim 10, wherein the operation of iteratively determining correlation comprises operation of determining at least one normalization coefficient associated with the at least one normalizing variable for the at least one benchmarking variable.

12. The system of claim 11, wherein the operation of normalizing comprises operation of applying a normalization coefficient within the at least one normalization coefficients to an associated benchmark variable to generate normalized asset data.

13. The system of claim 10, wherein the operations further comprises presenting benchmarked values for each asset along with the minimum, maximum and mean values.

14. The system of claim 10, wherein the operations further comprise collecting asset data from the plurality of energy assets, the plurality of energy assets being distributed across multiple locations.

15. The system of claim 10, wherein asset data for an asset is selected from a group comprising temperature of the asset, pressure associated with the asset, flow associated with the asset, power associated with the asset, run-hours of the asset, utilization level of the asset, damper states of the asset, operating speeds of the asset, operation state of the asset, humidity levels of the asset, consumption of the asset.

16. The system of claim 10, wherein the at least one profiling variable is selected from a group comprising type of operations, facility type, day of the week, climate zones, and asset make.

17. The system of claim 10, wherein the at least one benchmarking variable is selected from a group comprising zone temperature for an asset or an asset group, supply temperature for an asset, supply static pressure for an asset, refrigerant pressure for an asset, run-hours for an asset, temperature difference across asset input/output, consumption of an asset or an asset group, and setpoints maintained.

18. The system of claim 10, wherein the at least one normalizing variable is selected from a group comprising outside air temperature, outside air humidity, outside air dewpoint, age of an asset, area served, available capacity of the group, and zone temperature maintained by the group.

19. The system of claim 1, wherein constraints to filter the asset data comprises at least one of failed assets and assets with missing data.

20. A non-transitory computer-readable storage medium for benchmarking energy assets, when executed by a computing device, cause the computing device to:
filter asset data received from a plurality of energy assets based on constraints to generate filtered asset data;
create a plurality of data profiles using the filtered asset data based on profiling variables;
identify at least one benchmarking variable and at least one normalizing variable for the plurality of energy assets for a data profile in the plurality of data profiles;
iteratively determine correlation between the at least one benchmarking variable and the at least one normalizing variable; and
normalize the at least one benchmarking variable using the at least one normalizing variables in response to determining the correlation to generate benchmarks for each of the at least one benchmarking variable.
